(19) United States
(12) Patent Application Publication
(10) Pub. No.: US 2014/0089729 A1
(43) Pub. Date: Mar. 27, 2014

(54) STORAGE SYSTEM AND STORAGE CONTROL METHOD

(71) Applicants: Koji Sonoda, Chigasaki (JP); Go Uehara, Odawara (JP)

(72) Inventors: Koji Sonoda, Chigasaki (JP); Go Uehara, Odawara (JP)

(73) Assignee: Hitachi, Ltd., Tokyo (JP)

(21) Appl. No.: 13/643,903

(22) PCT Filed: Sep. 24, 2012
(86) PCT No.: PCT/JP2012/006060

§ 371 Date: Mar. 21, 2013

(51) Int. Cl. G06F 11/20

(52) U.S. Cl. CPC G06F 11/2087
USPC 714/6.21

(57) ABSTRACT

A storage system includes a plurality of nonvolatile memory devices that each includes a plurality of nonvolatile memory chips, and a storage controller configured to perform input and output of data to and from a RAID group comprised by storage areas of the plurality of nonvolatile memory devices. A nonvolatile memory device identifies a failure occurrence area that is a storage area in which a failure occurred in the plurality of nonvolatile memory chips, excludes the failure occurrence area from a storage area allocated to the RAID group, and transmits failure occurrence information that is information relating to the failure that has occurred in the nonvolatile memory device to the storage controller. When the failure occurrence information is received, the storage controller reconstructs data that had been stored in a storage area including at least the failure occurrence area of the nonvolatile memory device.

### TECHNICAL FIELD

The present invention relates to storage control of a parity group (also referred to as a “RAID (Redundant Array of Independent Disks) group”) comprised by a plurality of nonvolatile memory devices.

### BACKGROUND ART

A FM (flash memory) device (for example, an SSD (Solid State Device)) that is one example of a nonvolatile memory device generally includes a plurality of FM chips. A storage system disclosed in, for example, Patent Literature 1, is known as a storage system that includes an FM device. Patent Literature 1 discloses the following technology. That is, a parity group comprises a plurality of FM chips, and a storage controller that exists in a storage system and that is coupled to the parity group controls the correspondence between the FM chips and the parity group. If a failure occurs in a FM chip, the FM device notifies the storage controller of the failure in the FM chip. When the storage controller receives the notification, the storage controller performs so-called “data correction” that restores data in the failed chip (FM chip in which the failure occurred). More specifically, the storage controller reads data from each of a plurality of FM chips other than the failed chip in the parity group that includes the failed chip, restores the data in the failed chip using the plurality of pieces of data that were read, and writes the restored data in a spare FM chip.

### CITATION LIST

### Patent Literature

### [PTL 1]

U.S. Patent Application Publication No. 2008/0189466

### SUMMARY OF INVENTION

### Technical Problem

When the capacity of an FM device is enlarged, the number of FM chips mounted on the FM device increases. Consequently, the probability of a failure occurring in an FM chip in the FM device rises. When a failure occurs in an FM chip, an uncorrectable error is generated. The storage controller cannot identify a site of a failure occurrence, and therefore, even if the failure is a localized failure, it is necessary to make the entire FM device the object of replacement.

Further, according to Patent Literature 1, it is necessary for the storage controller to obtain the information inside the FM device in chip units.

### Solution to Problem

A storage system comprises a plurality of nonvolatile memory devices, and a storage controller configured to perform input and output of data to and from a RAID group comprised by storage areas of the plurality of nonvolatile memory devices. Each nonvolatile memory device is provided with a plurality of nonvolatile memory chips, and a nonvolatile memory controller coupled to the plurality of nonvolatile memory chips and configured to input and output of data to and from the plurality of nonvolatile memory chips.

The nonvolatile memory controller is configured to identify a failure occurrence area that is a storage area in which a failure has occurred in the plurality of nonvolatile memory chips of the nonvolatile memory device, exclude the failure occurrence area in the nonvolatile memory chip from a storage area that is allocated to the RAID group, and transmit failure occurrence information that is information relating to a failure that has occurred in the nonvolatile memory device to the storage controller.

The storage controller reconstructs data of the RAID group that had been stored in a storage area including at least the failure occurrence area of the nonvolatile memory device.

### Advantageous Effects of Invention

According to the present invention, even when a failure has occurred in a nonvolatile memory device, the nonvolatile memory device can continue to be used.

### BRIEF DESCRIPTION OF DRAWINGS

FIG. 1 is a configuration diagram of a computer system according to Embodiment 1.

FIG. 2 is a configuration diagram of a storage system according to Embodiment 1.

FIG. 3 is configuration diagram illustrating an example of RGs and LUs.

FIG. 4 is a configuration diagram of a flash memory package according to Embodiment 1.

FIG. 5 is a view that illustrates an example of an RG management table according to Embodiment 1.

FIG. 6 is a view that illustrates an example of an LU management table according to Embodiment 1.

FIG. 7 is a view that illustrates an example of address space on an FMPK belonging to an RG according to Embodiment 1.

FIG. 8 is a view that illustrates an example of page mapping in an FMPK according to Embodiment 1.

FIG. 9 is a view that illustrates an example of a logical/physical conversion table according to Embodiment 1.

FIG. 10 is a view for describing mapping of chunk units according to Embodiment 1.

FIG. 11 is a view for describing logical address space and physical address space according to Embodiment 1.

FIG. 12 is a view that illustrates an example of a physical/logical conversion table according to Embodiment 1.

FIG. 13 is a view that illustrates an example of an FMPK management table according to Embodiment 1.

FIG. 14 is a view for describing an overview of processing according to Embodiment 1.

FIG. 15 is a flowchart of failure countermeasure processing according to Embodiment 1.

FIG. 16 is a flowchart of failure area identification/isolation processing according to Embodiment 1.

FIG. 17 is a flowchart of all-pages check processing according to Embodiment 1.

FIG. 18 is a schematic diagram that illustrates the manner in which data reconstruction processing is performed according to Embodiment 1.

FIG. 19 is a flowchart of data reconstruction processing according to Embodiment 1.

FIG. 20 is a flowchart of partial data reconstruction processing according to Embodiment 1.

FIG. 21 is a configuration diagram of a computer system according to Embodiment 2.

### DESCRIPTION OF EMBODIMENTS

Some embodiments of the present invention are described below with reference to the accompanying drawings. It should be noted that the embodiments described below are not intended to limit the technical scope of the present invention as set forth in the claims, and it is not necessarily the case that all of the components and combinations thereof that are described in the following embodiments are essential in the solution means according to the present invention.

Note that, although in the following description, in some cases the term “aaa table” is used to describe various kinds of information, the various kinds of information may also be represented with a data structure other than a table. The term “aaa table” can be referred to as “aaa information” to indicate that the various kinds of information do not depend on the data structure.

Further, in the following description, although in some cases processing is described in a manner that takes a “program” as the subject, since a program performs given processing while appropriately using storage resources (for example, memory) and/or a communication interface device when the program is executed by a processor (for example, a CPU (Central Processing Unit)), the processing may also be described as being performed by a processor as the subject. Processing which is described as being performed by a program as the subject may also be described as being performed by a processor or a controller (for example, a system controller, an FM controller or the like) comprised by the processor. Further, a controller may be the processor itself, and may include a hardware circuit that performs some or all of the processing that the controller performs. A program may be installed in respective controllers from a program source. A program source may be, for example, a program distribution server or a storage medium.

Furthermore, in the following description, it is assumed that a nonvolatile memory is a recordable memory (which is a memory cannot write data newly in the written area without erasing processing to the area (for example, which is a memory configured to write data in address order) such as a flash memory (FM). It is assumed that the flash memory is of a kind in which erasing is performed in block units and access is performed in page units, and typically is a NAND-type flash memory. One block comprises a plurality of pages. However, another kind of flash memory (for example, a NOR-type flash memory) may be used instead of a NAND-type flash memory. Further, another kind of nonvolatile memory, for example, a phase change memory may be adopted instead of the flash memory.

### Embodiment 1

First, a computer system according to Embodiment 1 is described.

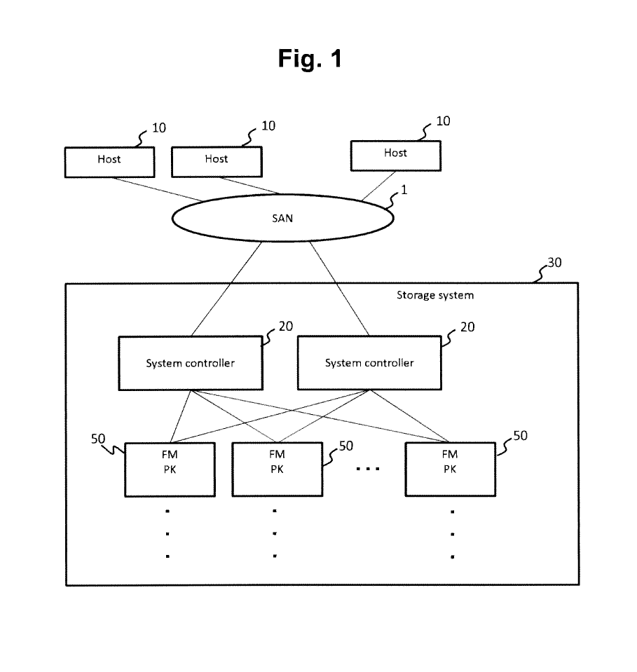

FIG. 1 is a configuration diagram of a computer system according to Embodiment 1.

The computer system includes a host computer (host) 10 and a storage system 30. The host computer 10 and the storage system 30 are coupled through a communication network, for example, a SAN (Storage Area Network) 1. The computer system may include a plurality of the host computers 10. In that case, the storage system 30 is coupled to the plurality of host computers 10 through the SAN 1.

The storage system 30 includes a plurality of FMPKs (Flash Memory Packages) 50, and a system controller 20 that controls each FMPK 50. The FMPK 50 is an example of a nonvolatile memory device. The system controller 20 is, for example, a RAID controller. The storage system 30 includes a plurality of the system controllers 20. Each system controller 20 is coupled to the host computer 10 through the SAN 1. Each system controller 20 is also coupled to the plurality of FMPKs 50. Note that the storage system 30 may also be configured to include only a single system controller 20.

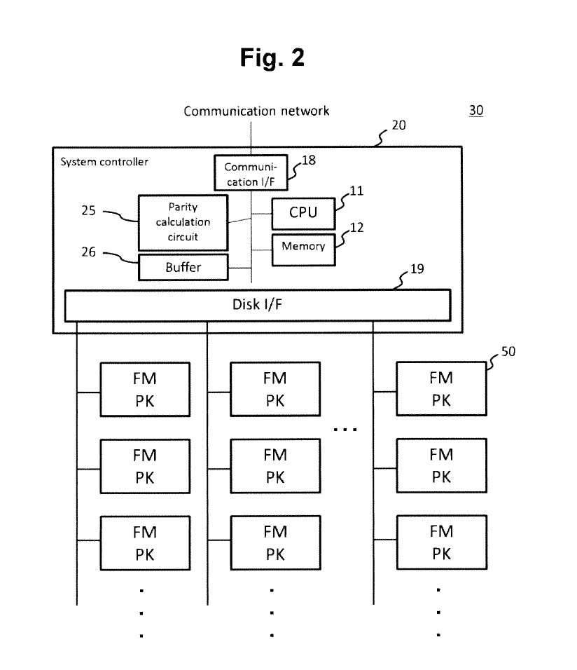

FIG. 2 is a configuration diagram of the storage system according to Embodiment 1.

The storage system 30 includes the system controller 20 and a plurality of the FMPKs 50. The system controller 20 has a communication I/F (interface) 18, disk I/F 19, a CPU 11, a memory 12, a buffer 26, and a parity calculation circuit 25. The communication I/F 18 is a communication interface device for communicating with another apparatus through the SAN 1. The disk I/F 19 is an interface device for performing data transfers between the system controller 20 and the FMPK 50. The memory 12 stores a program and various kinds of information for controlling the FMPKs 50. For example, the memory 12 stores a program and various kinds of information for a RAID function that uses the plurality of FMPKs 50. The parity calculation circuit 25 calculates a parity or an intermediate parity. The CPU 11 executes various kinds of processing by executing a program based on information stored in the memory 12. The buffer 26 is, for example, a volatile memory such as a DRAM (Dynamic Random Access Memory). The buffer 26 temporarily stores data to be written to the FMPK 50, data that is read from the FMPK 50, and data that is being subjected to a parity calculation and the like. Note that in a case where all the FMPKs 50 coupled to the system controller 20 include a parity calculation circuit, the system controller 20 need not include the parity calculation circuit 25.

Hereunder, an example of a case where the system controller 20 performs RAID 5 control is described. In this connection, the system controller 20 may also perform control of another RAID level with redundancy such as RAID 1 or RAID 6. The system controller 20 associates an RG (RAID Group), an LU (Logical Unit; sometimes referred to as “logical volume”), and the FMPKs 50.

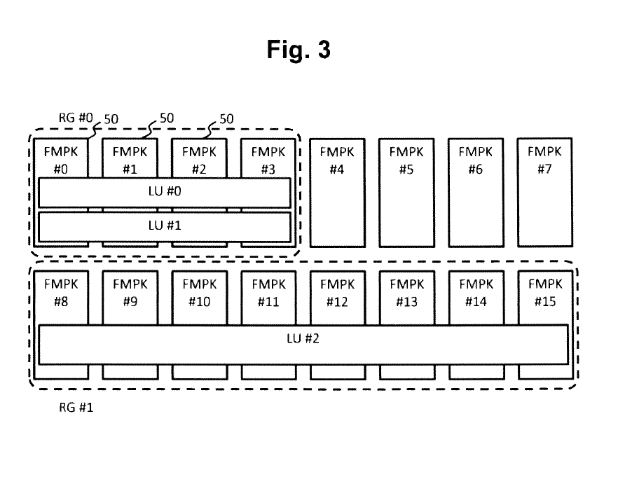

FIG. 3 is configuration diagram illustrating an example of RGs and LUs.

The system controller 20 allocates several FMPKs 50 to an RG, and allocates a part or all of the storage area of the RG to an LU. In this connection, a logical volume may also be a virtual volume for which the capacity of the volume was virtualized by means of thin provisioning technology. A physical storage area for storing data is not allocated in advance to the virtual volume. A physical storage area is allocated to the virtual volume in predetermined units in accordance with a write request to the virtual volume.

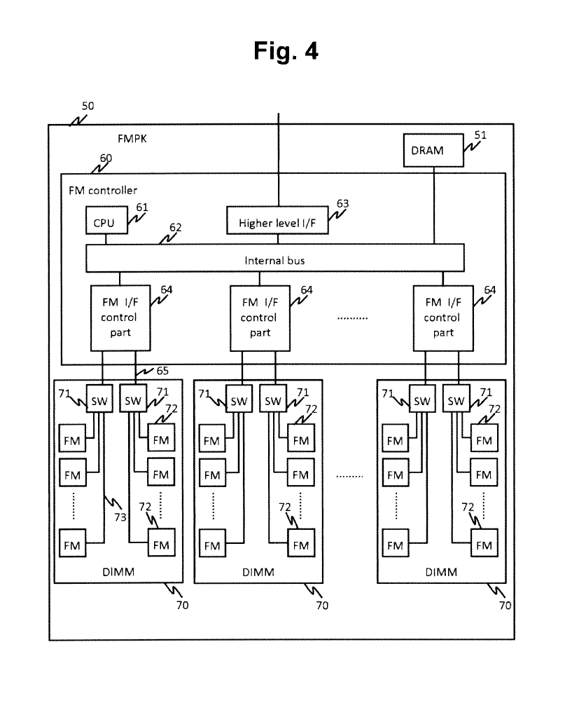

FIG. 4 is a configuration diagram of a flash memory package according to Embodiment 1.

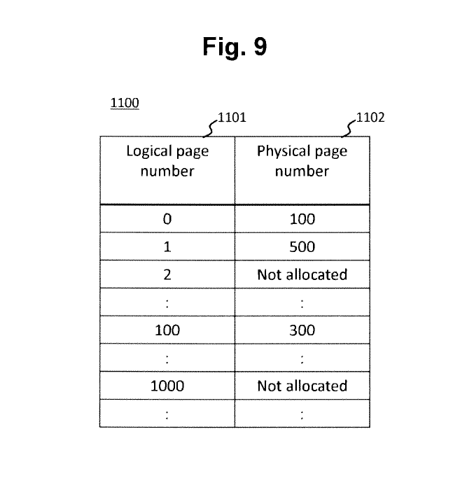

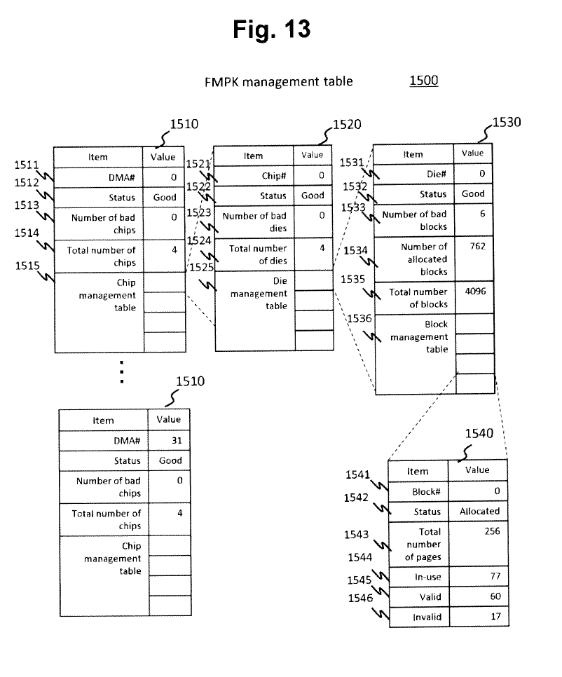

The FMPK 50 includes a DRAM (Dynamic Random Access Memory) 51 as an example of a main storage memory, an FM controller 60 as an example of a nonvolatile memory controller, and a plurality of (or one) DIMM (Dual Inline Memory Module) 70. The DRAM 51 stores data and the like that is used by the FM controller 60. The DRAM 51, for example, stores a logical/physical conversion table 1100 (see FIG. 9), a physical/logical conversion table 1200 (see FIG. 12), and an FMPK management table 1500 (see FIG. 13) and the like. The DRAM 51 may be mounted in the FM controller 60, or may be mounted in a separate member to the FM controller 60.

The FM controller 60, for example, is comprised by a single ASIC (Application Specific Integrated Circuit), and includes a CPU 61, an internal bus 62, a higher level I/F 63, and a plurality of (or a single) FM I/F control part 64. The internal bus 62 is communicably coupled to the CPU 61, the higher level I/F 63, the DRAM 51, and the FM I/F control part 64.

The higher level I/F 63 is coupled to the disk I/F 19, and mediates communication between the FM controller 60 and the system controller 20. The higher level I/F 63 is, for example, a SAS I/F. The FM I/F control part 64 mediates data exchanges with a plurality of FM chips 72. According to the present embodiment, the FM I/F control part 64 includes a plurality of sets of buses (data buses and the like) that carry out exchanges with the FM chips 72, and mediate data exchanges with the plurality of FM chips 72 using the plurality of buses. According to the present embodiment, the FM I/F control part 64 is provided for each DIMM 70, and the FM I/F control part 64 mediates communication with the plurality of FM chips 72 of the DIMM 70 to which the FM I/F control part 64 is coupled. In this connection, a configuration may also be adopted in which the number of DIMMs 70 that the FM I/F control part 64 is responsible for is two or more. The CPU 61 executes various kinds of processing by executing a program stored in the DRAM 51 (or an unshown other storage area). A plurality of CPUs 61 may also be provided, and the plurality of CPUs 61 may share the various kinds of processing. Specific processing by the CPU 61 is described later.

The DIMM 70 includes one or more SW 71 and a plurality of the FM chips 72. The FM chips 72 are, for example, MLC (Multi Level Cell) NAND flash memory chips. The MLC FM chip has a characteristic that, in comparison to an SLC FM chip, although the number of times the chip is rewritable is less, the storage capacity per cell is large. A recordable memory (for example, a phase change memory) may be used instead of the FM chip 72.

The SW 71 is coupled through a bus 65 including a data bus to the FM I/F control part 64. According to the present embodiment, the SWs 71 are provided so as to correspond on a one-to-one basis with a set of buses 65 that include a data bus that are coupled to the FM I/F control part 64. The SWs 71 are also coupled through buses 73 including a data bus to the plurality of FM chips 72. The FM controller 60 can perform a DMA (Direct Memory Access) transfer with respect to each bus 65. Herein, a plurality of the FM chips 72 that are coupled to one set of buses 65 is referred to as a “bus group (DMA group)”, and is sometimes referred to simply as a “DMA”. The SW 71 is configured so as to be able to selectively couple the bus 65 from the FM I/F control part 64 and the bus 73 of any FM chip 72. In this case, since the SW 71 and the plurality of FM chips 72 are provided in the DIMM 70 and wiring is performed, it is not necessary to separately prepare a connector for connecting these components, and thus the required number of connectors can be reduced.

In this connection, in FIG. 4, although each FM chip 72 is directly coupled to the SW 71 and is not coupled thereto through another FM chip 72, a configuration may also be adopted in which the respective FM chips 72 are coupled to the SW 71 through another FM chip 72. That is, two or more of the FM chips 72 that are arranged in series may be coupled to the SW 71. Further, the FM controller 60 may also comprise a parity calculation circuit that calculates a parity or an intermediate parity.

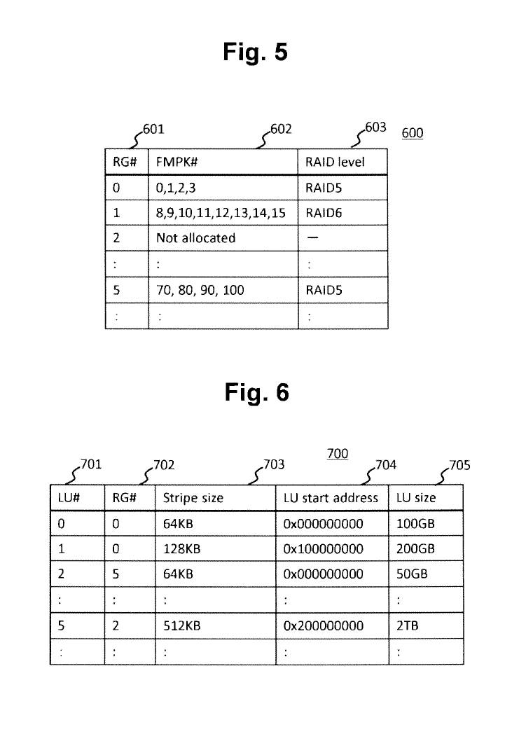

FIG. 5 is a view that shows an example of an RG management table according to Embodiment 1.

The system controller 20 writes the relationship between RGs (RAID Group), LUs (Logical Unit), and FMPKs 50 in an RG management table 600 and an LU management table 700 in the memory 12.

The RG management table 600 includes records that correspond to each RG. The records corresponding to each RG include fields for an RG number (#) 601, an FMPK number (#) 602, and a RAID level 603. An RG number that shows the RG corresponding to the record is stored in the field for the RG# 601. FMPK numbers showing the FMPKs 50 allocated to the RG corresponding to the record are stored in the field for the FMPK# 602. The RAID level of the RG corresponding to the relevant record is stored in the field for the RAID level 603.

FIG. 6 is a view that shows an example of an LU management table according to Embodiment 1.

The LU management table 700 includes records that correspond to each LU. The records corresponding to each LU include fields for an LU number (#) 701, an RG number (#) 702, a stripe size 703, an LU start address 704, and an LU size 705. An LU number of an LU corresponding to the record is stored in the field for the LU# 701. An RG number that shows the RG in which the LU is stored that corresponds to the record is stored in the field for the RG# 702. A size (stripe size) of a stripe block in the LU corresponding to the record is stored in the field for the stripe size. A starting logical address (LU start address) of the LU that corresponds to the record is stored in the field for the LU start address 704. The size (LU size) of the LU that corresponds to the record is stored in the field for the LU size 705.

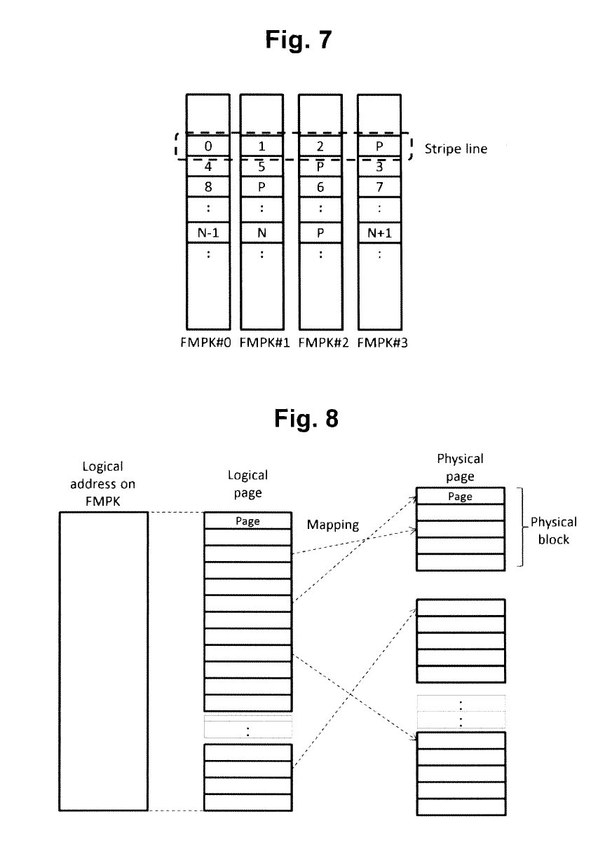

FIG. 7 is a view that illustrates an example of address space on an FMPK belonging to an RG according to Embodiment 1. FIG. 7 shows the address space (logical address space) of RG#0 of RAID 5.

As shown in FIG. 7, the system controller 20 allocates FMPK #0 to FMPK #3 as four FMPKs 50 to the RG#0 of RAID 5. Further, the system controller 20 allocates a continuous area from the address space on the RG#0 to the LU#0. The system controller 20 allocates a stripe line (corresponds to a cache segment) across the address space on the FMPK #0 to FMPK #3, and allocates a stripe block and parity in stripe line order and FMPK number order. In this case, for each stripe line, the system controller 20 shifts the FMPK numbers with respect to which the stripe block and the parity is allocated. The system controller 20 writes information relating to the RG#0, the LU#0 and the LU#1 in the RG management table 600 and the LU management table 700.

FIG. 8 is a view that shows an example of page mapping in an FMPK according to Embodiment 1.

The logical address space on the FMPK 50 is divided into a plurality of logical pages of a predetermined page size. On the other hand, the physical address space on the FMPK 50 is divided into a plurality of physical blocks of a predetermined block size. Each physical block is divided into a plurality of physical pages of a predetermined page size. The page size of the logical page and the page size of the physical page is the same. The physical pages are mapped to the logical pages. Note that, another physical area such as a physical block may be used instead of a physical page. Further, another logical area such as a logical unit may be used instead of a logical page.

FIG. 9 is a view that shows an example of a logical/physical conversion table according to Embodiment 1.

The FM controller 60 associates logical pages with physical pages, and writes the relation in the logical/physical conversion table 1100 of the DRAM 51. The logical/physical conversion table 1100 includes records that correspond to each logical page. The records that correspond to each logical page include a field for a logical page number 1101 and a field for a physical page number 1102. A logical page number that shows a logical page corresponding to the relevant record is stored in the field for the logical page number 1101. A physical page number of a physical page that is allocated to the corresponding to the relevant record is stored in the field for the physical page number 1102. Note that when a physical page has not been allocated with respect to a logical page, “Not allocated” is configured in the field for the physical page number 1102.

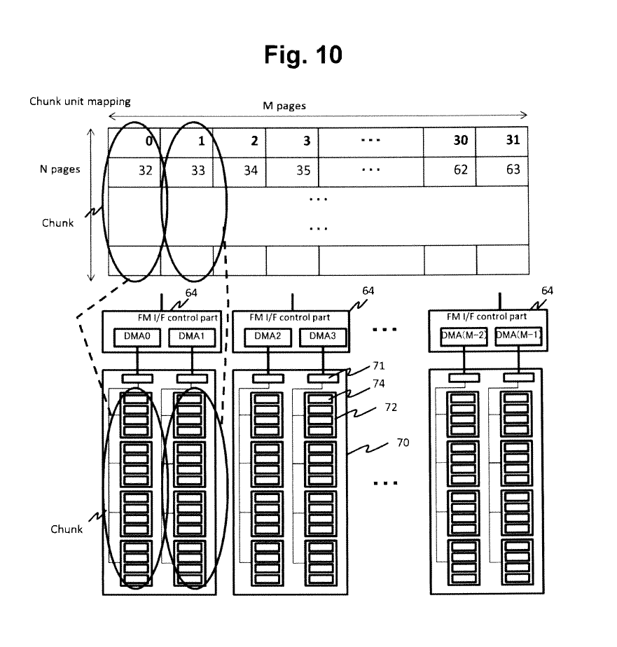

FIG. 10 is a view for describing mapping of chunk units according to Embodiment 1.

FIG. 10 illustrates an example in a case where the logical address space of a single logical unit is divided into M*N logical pages and managed. Here, M and N are integers. M represents the number of buses 65 that are coupled to the FM controller 60 in the FMPK 50. In FIG. 10, a case is illustrated in which M=32. In this connection, it is assumed that numbers 0, 1 . . . , are assigned in sequence from the start to the logical pages.

As shown in FIG. 10, the logical address space of the logical unit is divided into M chunks and managed. Each chunk is comprised by, for example, N logical pages that are staggered by M logical pages, as in the manner of logical pages 0, 32, 64 . . . or the like. In the present embodiment, the FM controller 60 manages so as to allocate physical pages of a plurality of FM chips 72 that are coupled to the same bus 65 to logical pages that belong to the same chunk. Consequently, it is possible to identify a chunk to which a physical page of the FM chip 72 is allocated, and further, to identify a logical address that is allocated to a chunk.

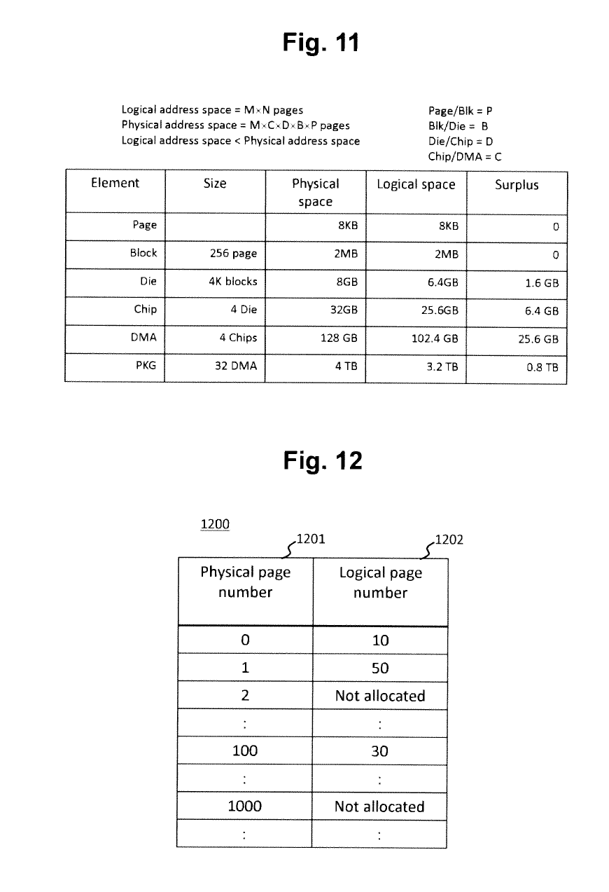

FIG. 11 is a view for describing logical address space and physical address space according to Embodiment 1.

The capacity of the logical address space of the FMPK 50 is a capacity of M*N pages. In contrast, the capacity of the physical address space is a capacity of M*C*D*B*P pages. In this case, reference character C denotes the number of chips in one DMA, reference character D denotes the number of dies in one chip, reference character B denotes the number of blocks in one die, and reference character P denotes the number of pages in one block.

In this case, in the FMPK 50, the capacity of the logical address space is less than the capacity of the physical address space, and there is thus a surplus in the capacity of the physical address space. A physical area that corresponds to this surplus is a area that is utilized as a physical page that is newly allocated when overwriting occurs with respect to a logical page of the FM chip 72, is utilized for so-called “reclamation”, and is utilized to avoid using a area (a page or the like) in which a failure occurred, and is not a dedicated area for a time that a failure occurs.

As a more specific example, a case will now be described in which the FMPK 50 includes, for example, 32 DMAs (DMA groups), a single DMA includes four FM chips 72, a single FM chip 72 includes four dies, a single die includes 4K blocks, and a single block includes 256 pages.

The capacity corresponding to the logical address space and the physical capacity for one page are the same amount (for example, 8 KB). In addition, the capacity corresponding to the logical address space and the capacity corresponding to the physical address space are also the same amount (for example, 2 MB) for each block.

In contrast, for each die, the capacity corresponding to the logical address space is 6.4 GB and the capacity corresponding to the physical address space is 8.0 GB, and there is thus a surplus of 1.6 GB. Further, for each chip, the capacity corresponding to the logical address space is 25.6 GB and the capacity corresponding to the physical address space is 32 GB, and there is thus a surplus of 6.4 GB. In addition, for each DMA, the capacity corresponding to the logical address space is 102.4 GB and the capacity corresponding to the physical address space is 128 GB, and there is thus a surplus of 25.6 GB. Furthermore, for each FMPK 50, the capacity corresponding to the logical address space is 3.2 TB and the capacity corresponding to the physical address space is 4 TB, and there is thus a surplus of 0.8 TB.

FIG. 12 is a view showing an example of a physical/logical conversion table according to Embodiment 1.

The FM controller 60 associates logical pages with physical pages and writes the relation in the physical/logical conversion table 1200 of the DRAM 51. The physical/logical conversion table 1200 is a so-called “reverse lookup table” of the logical/physical conversion table 1100. The physical/logical conversion table 1200 is an example of physical/logical conversion information. The physical/logical conversion table 1200 includes records that correspond to each physical page. The records that correspond to each physical page include a field for a physical page number 1201 and a field for a logical page number 1202. A physical page number that shows a physical page that corresponds to the relevant record is stored in the field for the physical page number 1201. A logical page number of a logical page to which the physical page that corresponds to the relevant record is allocated is stored in the field for the logical page number 1202. In this connection, when a physical page is not allocated to a logical page, or when data of the physical page is compressed, “Not allocated” is configured in the field for the logical page number 1202.

FIG. 13 is a view showing an example of an FMPK management table according to Embodiment 1.

The FMPK management table 1500 is a table that manages the status of the FMPK 50, and for example, manages the statuses of the DMAs, chips, dies, and blocks, respectively. The FMPK management table 1500 is provided in correspondence with each FMPK 50. The FMPK management table 1500 is stored in the DRAM 51, and is utilized for processing relating to management of the FMPK 50 by the FM controller 60.

The FMPK management table 1500 includes a DMA management table 1510 for managing each DMA, a chip management table 1520 for managing each chip, a die management table 1530 for managing each die, and a block management table 1540 for managing each block.

The DMA management table 1510 includes fields for DMA# 1511, Status 1512, Number of bad chips 1513, Total number of chips 1514, and Chip management table 1515, respectively. A number (DMA #) of a DMA (DMA group) corresponding to the DMA management table 1510 is stored in the DMA# 1511 field. The status of the relevant DMA is stored in the Status 1512 field. If the relevant DMA is in a usable state, “Good” is stored in the Status 1512 field, while if the relevant DMA is in an unusable state (a state in which a failure has occurred), “Bad” is stored in the Status 1512 field. The number of bad chips among the FM chips 72 belonging to the relevant DMA is stored in the Number of bad chips 1513 field. The total number of FM chips 72 belonging to the relevant DMA is stored in the Total number of chips 1514 field. A pointer to the chip management table 1520 that manages the status of each chip belonging to the relevant DMA is stored in the Chip management table 1515 field.

The chip management table 1520 includes fields for Chip# 1521, Status 1522, Number of bad dies 1523, Total number of dies 1524, and Die management table 1525, respectively. A number (chip #) of a chip corresponding to the chip management table 1520 is stored in the Chip# 1521 field. If the relevant chip is in a usable state, “Good” is stored in the Status 1522 field, while if the relevant chip is in an unusable state (a state in which a failure has occurred), “Bad” is stored in the Status 1522 field. The number of bad dies among the dies belonging to the relevant chip is stored in the Number of bad dies 1523 field. The total number of dies belonging to the relevant chip is stored in for Total number of dies 1524 field. A pointer to the die management table 1530 that manages the status of each die belonging to the relevant chip is stored in the Die management table 1525 field.

The die management table 1530 includes fields for Die# 1531, Status 1532, Number of bad blocks 1533, Number of allocated blocks 1534, Total number of blocks 1535, and Block management table 1536, respectively. A number (die #) of a die corresponding to the die management table 1530 is stored in the Die# 1531 field. If the relevant die is in a usable state, “Good” is stored in the Status 1532 field, while if the relevant die is in an unusable state (a state in which a failure has occurred), “Bad” is stored in the Status 1532 field. The number of bad blocks among the blocks belonging to the relevant die is stored in the Number of bad blocks 1533 field. The number of blocks including physical pages allocated to logical pages among the blocks belonging to the relevant die is stored in the Number of allocated blocks 1534 field. The total number of blocks belonging to the relevant die is stored in the Total number of blocks 1535 field. A pointer to the block management table 1540 that manages the status of each block belonging to the relevant die is stored in the Block management table 1536 field.

The block management table 1540 includes fields for Block# 1541, Status 1542, Total number of pages 1543, In-use 1544, Valid 1545, and Invalid 1546, respectively. A number (Block #) of a block corresponding to the block management table 1540 is stored in the Block# 1541 field. The status of the block is stored in the Status 1542 field. According to the present embodiment, if the relevant block is bad (in a state in which a failure has occurred), “Bad” is stored in the field for Status 1542, if physical pages of the relevant block are allocated to logical pages, “Allocated” is stored in the field for Status 1542, and if physical pages of the relevant block are not allocated to logical pages, “Not allocated” is stored in the field for Status 1542. The total number of pages in the relevant block is stored in the Total number of pages 1543 field. The number of pages that are in use in the relevant block is stored in the In-use 1544 field. The number of valid pages (pages allocated to logical pages) in the relevant block is stored in the Valid 1545 field. The number of invalid pages (pages for which allocation to a logical page has been cancelled) in the relevant block is stored in the Invalid 1546 field.

Next, an overview of processing by the computer system according to Embodiment 1 is described.

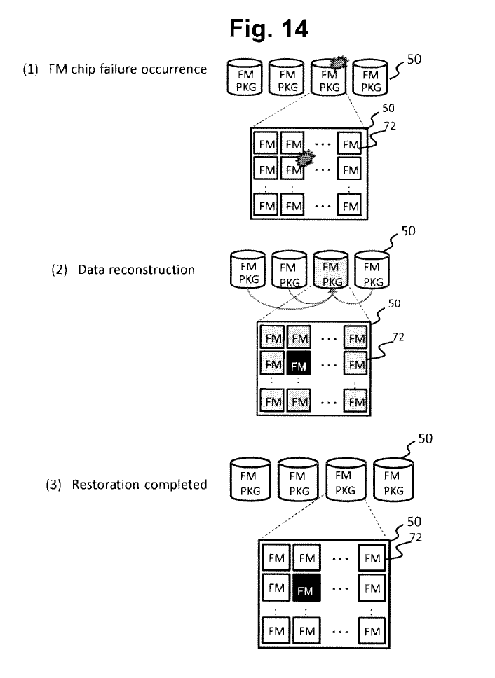

FIG. 14 is a view that describes an overview of processing according to Embodiment 1.

There is a possibility of a failure occurring in some or all of the FM chips 72 of any of the FMPKs 50 of the computer system. In this case, the term “failure occurring in the FM chip 72” does not refer to a failure that is ascribable to repetition of writing and erasing operations with respect to the FM chip 72, but rather to a hardware related failure that is due to some other cause.

As shown in FIG. 14(1), when a failure occurs in any of the FM chips 72, a large amount of uncorrectable errors, that is, errors that cannot be corrected by an error correcting code, occur for a short period of time in the relevant FMPK 50.

When a failure occurs in the FM chip 72 in this manner, as shown in FIG. 14(2), the FMPK 50 blocks a area in which the failure has occurred (failure occurrence area; in this case, the entire FM chip 72) of the FM chip 72 in which the failure has occurred, and sends the system controller 20 information relating to the failure occurrence (failure occurrence information; for example, information merely to the effect that a failure has occurred, or failure occurrence area information indicating a area in which the failure has occurred or a area that includes the relevant area or the like). Based on the failure occurrence information received from the FMPK 50, the system controller 20, for example, temporarily blocks all or a part of the area of the FMPK 50 in which the failure has occurred, and executes reconstruction of data with respect to the relevant FMPK 50 without replacing the FMPK 50 in which the failure has occurred. In this case, during the data reconstruction executed by the system controller 20, since the failure occurrence area in which the failure has occurred or a area including the failure occurrence area in the FM chip 72 is blocked, the reconstructed data is not stored therein. Therefore, the reconstructed data is not affected by the failure that occurred earlier.

Thereafter, as shown in FIG. 14(3), the system controller 20 ends the operation for blocking the FMPK 50 in which the failure occurred, and uses the relevant FMPK 50 as normal. Thus, according to Embodiment 1, it is possible to reconstruct data and utilize the data without replacing the FMPK 50 in which a failure occurred.

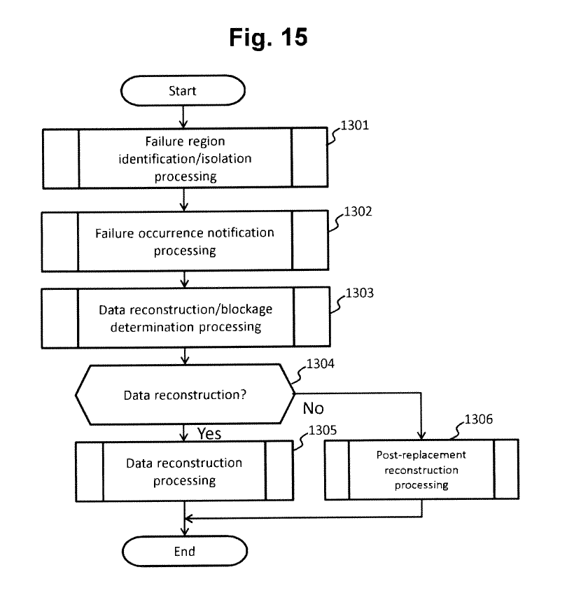

FIG. 15 is a flowchart of failure countermeasure processing according to Embodiment 1.

In the failure countermeasure processing, first, the respective FMPKs 50 execute failure area identification/isolation processing to identify a area in which a failure has occurred (failure occurrence area) in the relevant FMPK 50 and isolate the area so that the area is not used (step 1301). Subsequently, a FMPK 50 that has identified a failure occurrence area in the failure area identification/isolation processing executes failure occurrence notification processing to notify information (failure occurrence information) relating to the failure occurrence to the system controller 20 (step 1302). In this connection, if there is no failure occurrence area, the FMPK 50 does not execute the processing from step 1302 onwards, and ends the failure countermeasure processing. Next, upon receiving the failure occurrence information, the system controller 20 executes data reconstruction/blockage determination processing that determines whether to reconstruct data or to block the FMPK 50 (step 1303).

Subsequently, the system controller 20 determines whether or not the result determined by the data reconstruction/blockage determination processing is to perform data reconstruction (step 1304). If the determined result is to perform data reconstruction (“Yes” in step 1304), the system controller 20 executes data reconstruction processing (step 1305) without replacing the FMPK 50, and thereafter ends the failure countermeasure processing. In contrast, if the determined result is not to perform data reconstruction (“No” in step 1304), the system controller 20 waits for the FMPK 50 in which the failure has occurred to be replaced, and thereafter executes post-replacement reconstruction processing (step 1306), and subsequently ends the failure countermeasure processing.

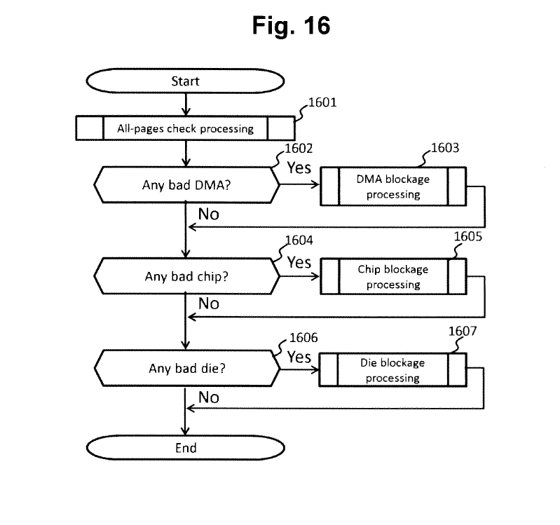

FIG. 16 is a flowchart of the failure area identification/isolation processing according to Embodiment 1.

The failure area identification/isolation processing is processing corresponding to step 1301 of the failure countermeasure processing shown in FIG. 15. The failure area identification/isolation processing, for example, is executed in each FMPK 50 at fixed intervals.

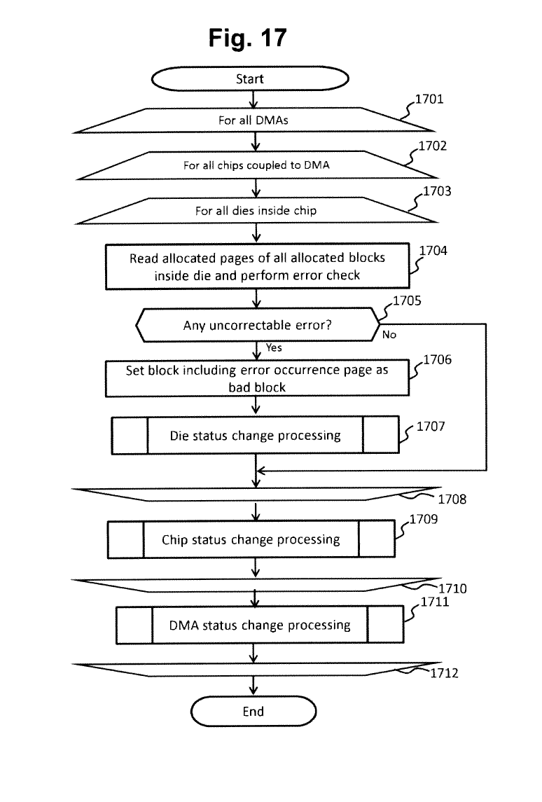

The FM controller 60 of the FMPK 50 executes all-pages check processing (see FIG. 17) that checks the status of physical pages stored in all the FM chips 72 in the FMPK 50 (step 1601). In this connection, a configuration may also be adopted so that, in the all-pages check processing, a physical page in which the occurrence of a failure has already been identified is excluded from the processing objects. The status relating to failure occurrence in each FMPK 50 is reflected in the FMPK management table 1500 by the all-pages check processing.

Next, the FM controller 60 refers to each DMA management table 1510 of the FMPK management table 1500 and determines whether or not there is a DMA management table 1510 in which the Status 1512 is configured to “Bad” (step 1602).

If the FM controller 60 determines as a result that there is a DMA management table 1510 in which the Status 1512 is configured to “Bad” (“Yes” in step 1602), the FM controller 60 executes DMA blockage processing for blocking DMAs (blockage object DMAs) that correspond to all DMA management tables 1510 in which the Status 1512 is configured to “Bad” (step 1603). Thereafter the FM controller 60 advances the processing to step 1604. In the DMA blockage processing, the FM controller 60 excludes all physical pages belonging to a blockage object DMA from physical pages that are allocatable to logical pages. Accordingly, thereafter the FM controller 60 does not allocate any of the physical pages belonging to a blockage object DMA to a logical page. That is, data that is stored in the FMPK 50 is not stored in a physical page in which the occurrence of a failure has been detected.

In contrast, if there is no DMA management table 1510 in which the Status 1512 has been configured to “Bad” (“No” in step 1602), the FM controller 60 advances the processing to step 1604.

Next, the FM controller 60 refers to the chip management tables 1520 of the FMPK management table 1500, and determines whether or not there is a chip management table 1520 in which the Status 1522 is configured to “Bad” (step 1604). In this connection, the chip management table 1520 of a chip belonging to a blockage object DMA may be excluded from the objects of the determination processing in step 1604.

If the FM controller 60 determines as a result that there is a chip management table 1520 in which the Status 1522 is configured to “Bad” (“Yes” in step 1604), the FM controller 60 executes chip blockage processing for blocking chips (blockage object chips) that correspond to all chip management tables 1520 in which the Status 1522 is configured to “Bad” (step 1605). Thereafter the FM controller 60 advances the processing to step 1606. In the chip blockage processing, the FM controller 60 excludes all physical pages belonging to a blockage object chip from physical pages that are allocatable to logical pages. Accordingly, thereafter the FM controller 60 does not allocate any of the physical pages belonging to a blockage object chip to a logical page. That is, data that is stored in the FMPK 50 is not stored in a physical page in which the occurrence of a failure has been detected.

In contrast, if there is no chip management table 1520 in which the Status 1522 has been configured to “Bad” (“No” in step 1604), the FM controller 60 advances the processing to step 1606.

Next, the FM controller 60 refers to the die management tables 1530 of the FMPK management table 1500, and determines whether or not there is a die management table 1530 in which the Status 1532 is configured to “Bad” (step 1606). In this connection, the die management table 1530 of a die belonging to a blockage object DMA or a blockage object chip may be excluded from the objects of the determination processing in step 1606.

If the FM controller 60 determines as a result that there is a die management table 1530 in which the Status 1532 is configured to “Bad” (“Yes” in step 1606), the FM controller 60 executes die blockage processing for blocking dies (blockage object dies) that correspond to all die management tables 1530 in which the status 1532 is configured to “Bad” (step 1607). Thereafter the FM controller 60 ends the processing. In the die blockage processing, the FM controller 60 excludes all physical pages belonging to a blockage object die from physical pages that are allocatable to logical pages. Accordingly, thereafter the FM controller 60 does not allocate any of the physical pages belonging to a blockage object die to a logical page. That is, data that is stored in the FMPK 50 is not stored in a physical page in which the occurrence of a failure has been detected.

In contrast, if there is no die management table 1530 in which the status 1532 has been configured to “Bad” (“No” in step 1606), the FM controller 60 ends the processing.

According to the above described failure area identification/isolation processing, a physical area in which a failure has occurred in the FMPK 50 can be identified, and processing can be performed so that the physical area is not allocated to a logical area of the RAID group

FIG. 17 is a flowchart of the all-pages check processing according to Embodiment 1.

The all-pages check processing is processing that corresponds to step 1601 in the failure area identification/isolation processing shown in FIG. 16. The FM controller 60 executes the processing of step 1701 to step 1712 with respect to each DMA. The FM controller 60 executes the processing of step 1702 to step 1710 with respect to all chips of the DMA group that is the processing object. Further, the FM controller 60 executes the processing of step 1703 to step 1708 with respect to all dies of the chip that is the processing object, respectively.

For each die that is a processing object, the FM controller 60 reads physical pages (allocated physical pages) that have been allocated to logical pages in all blocks in the die, and performs an error check on the data that is read (step 1704). In this case, the FM controller 60 can ascertain whether or not a physical page of a block is allocated to a logical page by referring to the Status 1542 of the block management table 1540 corresponding to the block. Further, when performing an error check on data that has been read, for example, based on an error correcting code that has been assigned to the data that is read, the FM controller 60 determines whether or not an error has occurred, and if an error has occurred, whether or not the error can be corrected with the error correcting code.

Based on the result of the error check, the FM controller 60 determines whether or not there is an uncorrectable error, that is, an error that cannot be corrected with the error correcting code (step 1705). If the FM controller 60 determines as a result that there is no uncorrectable error (“No” in step 1705), the FM controller 60 advances the processing to step 1708.

In contrast, if there is an uncorrectable error (“Yes” in step 1705), the FM controller 60 configures the Status 1542 of the block management table 1540 that corresponds to a block that includes a physical page in which an uncorrectable error occurred to “Bad” (step 1706), and advances the processing to step 1707.

In step 1707, the FM controller 60 performs die status change processing. In the die status change processing, if the Status 1542 of the respective block management tables 1540 corresponding to all blocks that include an allocated physical page in the die that is the processing object is “Bad”, the FM controller 60 configures the Status 1532 of the die management table 1530 corresponding to the relevant die to “Bad”, while in other cases the FM controller 60 does not change the die status. After the processing in step 1707 ends, the FM controller 60 advances the processing to step 1708.

In step 1708, if all the dies have not yet undergone processing as a processing object, the FM controller 60 shifts the processing to step 1703, while if all the dies have undergone processing as a processing object, the FM controller 60 advances the processing to step 1709.

In step 1709, the FM controller 60 performs chip status change processing. In the chip status change processing, if the Status 1532 of the respective die management tables 1530 corresponding to all dies in the chip that is the processing object is “Bad”, the FM controller 60 configures the Status 1522 of the chip management table 1520 corresponding to the relevant chip to “Bad”, while in other cases the FM controller 60 does not change the chip status. After the processing in step 1709 ends, the FM controller 60 advances the processing to step 1710.

In step 1710, if all the chips have not yet undergone processing as a processing object, the FM controller 60 shifts the processing to step 1702, while if all the chips have undergone processing as a processing object, the FM controller 60 advances the processing to step 1711.

In step 1711, the FM controller 60 performs DMA status change processing. In the DMA status change processing, if the Status 1522 of the respective chip management tables 1520 corresponding to all chips in the DMA that is the processing object is “Bad”, the FM controller 60 configures the Status 1512 of the DMA management table 1510 corresponding to the relevant DMA to “Bad”, while in other cases the FM controller 60 does not change the DMA status. After the processing in step 1711 ends, the FM controller 60 advances the processing to step 1712.

In step 1712, if all the DMAs have not yet undergone processing as a processing object, the FM controller 60 shifts the processing to step 1701, while if all the DMAs have undergone processing as a processing object, the FM controller 60 ends the all-pages check processing.

The all-pages check processing makes it possible for the FM controller 60 to appropriately ascertain the state of failure occurrence in the DMAs, chips, dies, and blocks of the FMPK 50, and manage the FMPK management table 1500.

Next, failure occurrence notification processing corresponding to step 1302 of the failure countermeasure processing shown in FIG. 15 is described.

The failure occurrence notification processing is executed by the FM controller 60, for example, in a case where a monitor request for monitoring that is to be executed at fixed intervals is received from the system controller 20. The monitoring request is one example of a query to check failure occurrence information. Note that, the FM controller 60 may also execute the failure occurrence notification processing when a read request is received from the system controller 20. Further, a configuration may also be adopted in which the FM controller 60 actively notifies the system controller 20.

In the failure occurrence notification processing, the FM controller 60 notifies the failure occurrence information to the system controller 20. The failure occurrence information may include, for example, either (1) information showing that a failure for which data reconstruction is required has occurred in the FMPK 50, or (2) information showing a logical area that corresponds to a physical area in which a failure occurred (failure occurrence area) in the FMPK 50 (failure occurrence area information: for example, an LBA (logical block address) of a logical area).

When the failure occurrence information includes the information of (1), the system controller 20 blocks all of the FMPK 50 in which the failure occurred and performs data reconstruction. In this case, when notifying failure occurrence information that includes only information showing that a failure that requires data reconstruction has occurred in the FMPK 50, since it is not necessary to identify a logical address of a logical area corresponding to the physical area in the FMPK 50, there is no necessity to store the physical/logical conversion table 1200 and, in addition, a processing load relating to processing for identifying a logical address is not generated.

On the other hand, when the failure occurrence information is the information of (2), the system controller 20 can block the entire FMPK 50 in which the failure occurred and perform data reconstruction, or can block a part of the storage area of the FMPK 50 that includes the failure occurrence area and perform data reconstruction. The failure occurrence area information may show a area using any kind of units among, for example, DBA units, chip units, die units, block units and page units. Further, as a method of identifying a logical area that corresponds to a physical area, for example, a method may be adopted in which the system controller 20 refers to the physical/logical conversion table 1200 and identifies the address of a logical area (for example, a logical page) corresponding to a physical area (for example, a physical page) in which a failure has occurred, or in which the system controller 20 identifies a chunk in which data is stored in the physical area in which a failure has occurred, and identifies a corresponding logical area by means of the logical address of the chunk. In this connection, when adopting a configuration in which identification is performed by means of a logical address of a chunk, it is good to manage the logical addresses of chunks in advance in, for example, the DRAM 51, and thus the processing load is lightened since it is not necessary to perform a search for a logical address using the logical/physical conversion table 1200. In contrast, when identifying a logical area in which a failure occurred by referring to the physical/logical conversion table 1200, in comparison to a case of using the logical address of a chunk, since the width of a logical area that is identified as a failure occurrence area can be suppressed, the processing load in the data reconstruction processing can be reduced.

In this case, it is sufficient to decide whether to identify the address of a logical area by means of the physical/logical conversion table 1200 or identify the address of a logical area by means of a chunk by taking into consideration the width or narrowness of the failure occurrence area and the cost when transmitting the failure occurrence area information. For example, in a case where the failure occurrence area is comparatively narrow (for example, a case where the failure occurrence area is of a degree that remains in die units), a configuration may be adopted that identifies an address of a logical area using the physical/logical conversion table 1200, and in a case where the failure occurrence area is wider than the aforementioned width, a configuration may be adopted that identifies an address of a logical area by means of a chunk.

Next, the data reconstruction/blockage determination processing corresponding to step 1303 of the failure countermeasure processing shown in FIG. 15 is described.

The data reconstruction/blockage determination processing is executed by the system controller 20. In the data reconstruction/blockage determination processing, the system controller 20 determines whether to perform data reconstruction without replacing the FMPK 50 in which a failure occurred, or to perform data reconstruction after blocking the FMPK 50 and replacing the FMPK 50 with a new FMPK 50.

The system controller 20 can determine whether to perform data reconstruction without replacing the FMPK 50 or to block and replace the FMPK 50 based on a predetermined determination criterion such as (1) the remaining life of the FMPK 50, (2) the frequency of data reconstruction with respect to the FMPK 50, or (3) information relating to the capacity of the physical area that has been removed by the failure in the FMPK 50.

In a case where the remaining life of the FMPK 50 as described in (1) is taken as the determination criterion, for example, a configuration may be adopted so as to determine to perform data reconstruction after replacing the FMPK 50 if the remaining life of the FMPK 50 is less than a predetermined threshold value, and in other cases to perform data reconstruction without replacing the FMPK 50. Thus, a situation can be appropriately prevented in which it is necessary to replace the FMPK 50 at a comparatively early stage due to the life of the FMPK 50 expiring after data reconstruction is performed. Further, in a case where the frequency of data reconstruction with respect to the FMPK 50 as described in (2) is taken as the determination criterion, for example, a determination may be made so that, after data reconstruction has already been performed a predetermined number of times with respect to the FMPK 50 that is the object of data reconstruction, data reconstruction is performed after replacing the FMPK 50. Thus, a situation can be appropriately prevented in which an FMPK 50 in which a failure that requires data reconstruction has occurred a predetermined number of times continues to be utilized. Furthermore, in a case where information relating to the capacity of the physical area that has been removed by the failure in the FMPK 50 as described in (3) is taken as the determination criterion, for example, a configuration may be adopted so as to determine to perform data without replacing the FMPK 50 if a ratio of the capacity of the physical area that has been removed by the failure with respect to the surplus area of the FMPK 50 is less than or equal to a predetermined threshold value, and to perform data reconstruction after replacing the FMPK 50 if the aforementioned ratio exceeds the predetermined threshold value. It is thereby possible to appropriately prevent the influence of a decrease in the performance of the FMPK 50 that is caused by a reduction in the surplus area.

Next, data reconstruction processing corresponding to step 1305 of the failure countermeasure processing shown in FIG. 15 is described.

In the data reconstruction processing, the system controller 20 may be configured to perform data reconstruction (entire data reconstruction) for the entire logical area of a RAID group stored in the FMPK 50, or may be configured to perform data reconstruction (partial data reconstruction) for a part of the logical area that includes the failure occurrence area among the entire logical area of the RAID group stored in the FMPK 50.

In this case, when the system controller 20 receives failure occurrence information that includes only information showing that a failure for which data reconstruction is required has occurred in the FMPK 50 from the FM controller 60, entire data reconstruction is performed.

In contrast, when the system controller 20 receives failure occurrence information that includes failure occurrence area information from the FM controller 60, one of entire data reconstruction and partial data reconstruction is selected and executed. In comparison to entire data reconstruction, when partial data reconstruction is executed, the data reconstruction time can be shortened, a time that the redundancy in the RAID group is lowered can be shortened, and a decrease in the reliability of the RAID group can be suppressed. Hereunder, the entire data reconstruction processing and the partial data reconstruction processing are described.

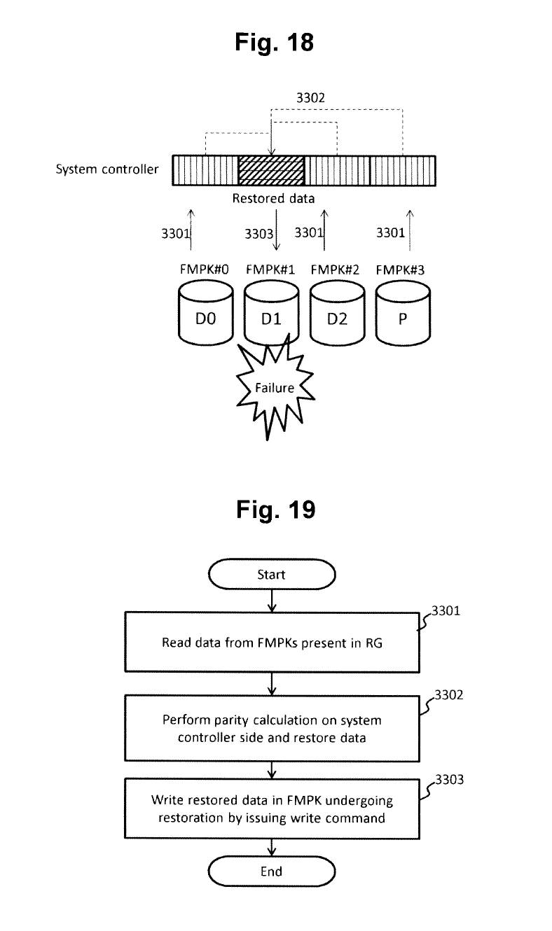

FIG. 18 is a schematic diagram illustrating the manner in which data reconstruction processing is performed by a DKC according to Embodiment 1. FIG. 19 is a flowchart of data reconstruction processing according to Embodiment 1.

The data reconstruction processing shown in FIG. 18 and FIG. 19 is processing that is executed when performing entire data reconstruction in the processing corresponding to step 1305 of the failure countermeasure processing shown in FIG. 15. In the example shown in FIG. 18, it is assumed that FMPKs #0, #1, #2, and #3 store D0, D1, D2, and P, respectively, that a failure has occurred in an FM chip 72 of the FMPK #1, and that the physical area of the relevant FM chip 72 is isolated from the physical areas that are allocatable to logical areas.

The system controller 20 reads D0, D2, and P from the FMPKs #0, #2, and #3 by issuing a read command to the FMPKs #0, #2, and #3 that are in a RAID group to which the FMPKs #0, #1, #2, and #3 belong (step 3301). Upon receiving the read command, the respective FM controllers 60 of the FMPKs #0, #2, and #3 read D0, D2, and P, respectively, and transfer the thus-read D0, D2, and P to the system controller 20. In this case, data or parity may be read.

Next, the system controller 20 generates restored data of D1 by calculating D1 based on D0, D2, and P (step 3302). Next, the system controller 20 writes the restored D1 in the FMPK #1 by issuing a write command to the FMPK #1 (step 3303), and ends the processing. The FM controller 60 of the FMPK #1 that receives the write command writes the received D1 in the FMPK #1. Note that, in the FMPK #1, since the physical area in which the failure occurred is isolated, D1 is not stored in the physical area in which the failure occurred. Note that, in the entire data reconstruction processing, the above described processing is repeatedly executed for all stripe blocks stored in an FMPK in which a failure occurred.

In the above described entire data reconstruction processing, a data transfer between the system controller 20 and the FM controller 60 when restoring data of a single stripe block is performed in the following manner.

(1) Data of an FMPK 50 other than the FMPK that is undergoing restoration is transferred to the system controller 20 from the FM controller 60 of the relevant FMPK 50.

(2) The restored data is transferred to the FM controller 60 of the FMPK that is undergoing restoration from the system controller 20.

It is thereby possible to suppress data transfers between the system controller 20 and an FM controller 60.

Further, according to the entire data reconstruction processing, since it is not necessary for the FM controller 60 to include failure occurrence area information, the processing load of the FM controller 60 can be reduced. In this connection, if there is a read request that specifies an address range corresponding to data stored in the FMPK that is undergoing restoration during execution of the entire data reconstruction processing, the system controller 20 performs a correction read based on data of an FMPK other than the FMPK that is undergoing restoration.

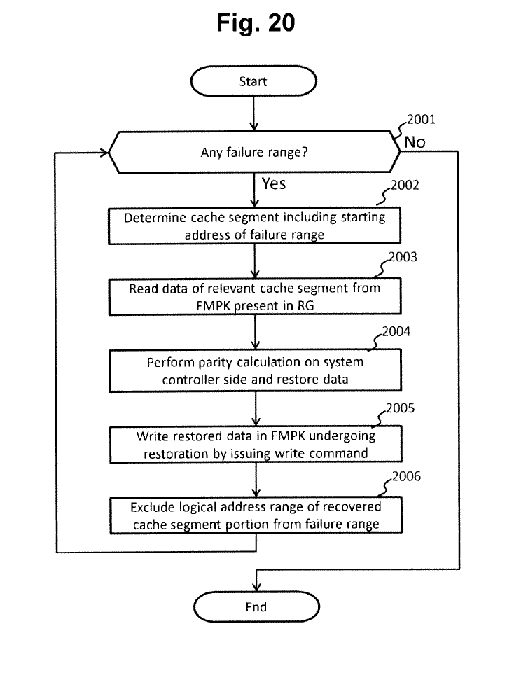

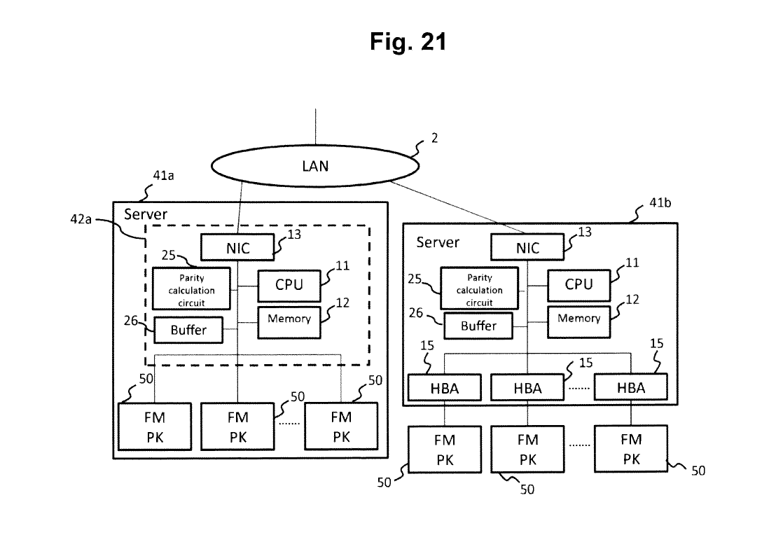

FIG. 20 is a flowchart of partial data reconstruction processing according to Embodiment 1. The partial data reconstruction processing shown in FIG. 20 is processing that is executed when performing partial data reconstruction in the processing corresponding to step 1305 of the failure countermeasure processing shown in FIG. 15.

The system controller 20 determines whether or not there is a failure range (step 2001). In this case, in an initial state, the failure range is the entire range included in the failure occurrence area information of the failure occurrence information of the FM controller 60.

If the system controller 20 determines as a result that there is a failure range (“Yes” in step 2001), the system controller 20 advances the processing to step 2002. In contrast, if there is no failure range (“No” in step 2001), since it means that reconstruction of data of the entire area that was the failure range in the initial state has been performed, the system controller 20 ends the partial data reconstruction processing.

In step 2002, the system controller 20 determines a cache segment (stripe line) that includes a starting address of the failure range (step 2002). In this connection, the cache segment can be determined based on the configuration of the RAID group. Subsequently, the system controller 20 reads data (also includes parity data; hereunder, referred to as “data”) of the relevant cache segment from an FMPK 50 (in which a failure has not occurred) that is present in the RAID group (step 2003).

Next, the system controller 20 performs a parity calculation based on the data of the relevant cache segment that has been read, and restores the data of the stripe block in which the failure occurred in the relevant cache segment (step 2004).

Next, the system controller 20 issues a write command to write the data that was restored (restored data) in the FMPK 50 that is undergoing restoration (step 2005). In the FMPK 50, in accordance with the write command, the FM controller 60 decides a physical area in which to store the restored data, and stores the restored data in the physical area. In this case, since the physical area in which the failure occurred is isolated, the restored data is not stored in the physical area in which the failure occurred.

Thereafter, the system controller 20 excludes the logical address range of the cache segment for which restoration was performed from the failure range (step 2006), and shifts the processing to step 2001.

According to the partial data reconstruction processing, since data reconstruction is performed only for a limited area that is an area included in the failure occurrence area information of the failure occurrence information of the FM controller 60, the time required for data reconstruction can be reduced. In this connection, during execution of the partial data reconstruction processing, if there is a read request corresponding to an address range of the RAID group that corresponds to an area that is undergoing restoration in the FMPK, it is sufficient for the system controller 20 to perform a correction read based on data of another FMPK, and if there is a read request corresponding to an address range of the RAID group that corresponds to a area other than an area that is undergoing restoration in the FMPK, it is sufficient for the system controller 20 to perform read processing as normal.

### Embodiment 2

Embodiment 2 is an example in which the storage system 30 according to Embodiment 1 is realized by a server.

FIG. 21 is a configuration diagram of a computer system according to Embodiment 2. In FIG. 21, components that are identical or correspond to components of the above described Embodiment 1 are denoted by the same reference symbols.

The computer system according to Embodiment 2 comprises a server 41a, a server 41b, and a plurality of FMPKs 50 that are coupled to the server 41b. The server 41a and server 41b are connected through a communication network, for example, a LAN (Local Area Network) 2.

The server 41a comprises a server controller 42a and a plurality of FMPKs 50 that are coupled to the server controller 42a. The server controller 42a comprises an NIC (Network Interface Card) 13 for coupling to a communication network such as a LAN 2, a memory 12, a CPU 11, a parity calculation circuit 25, and a buffer 26. The server controller 42a is an example of a RAID controller.

The server 41b comprises an NIC 13 for coupling to a communication network such as the LAN 2, a plurality of HBAs (Host Bus Adapters) 15 for coupling to the FMPKs 50, a memory 12, a CPU 11, a parity calculation circuit 25, and a buffer 26. The server 41b is an example of a RAID controller.

In the server controller 42a and the server 41b, a program and various kinds of information for controlling the FMPKs 50 are stored in the memory 12. The CPU 11 causes various functions to be realized by executing a program based on information stored in the memory 12. The server controller 42a and the server 41b may respectively perform control of a RAID that uses a plurality of the FMPKs 50 that are coupled to the server controller 42a or the server 41b, respectively.

One of the server controller 42a and the server 41b may issue an IO request to the other through the LAN 2, and may issue an IO request to its own FMPKs 50.

Although some embodiments have been described in the foregoing, it is to be understood that the present invention is not limited to the above embodiments, and naturally various changes are possible within a range that does not depart from the spirit and scope of the invention.

For example, although in the above embodiments a configuration is adopted in which the system controller 20 performs a parity calculation or the like to perform data reconstruction, the present invention is not limited thereto, and for example, a configuration may be adopted in which the FM controller 60 performs a parity calculation or the like to perform data reconstruction. In such case, it is necessary for the FM controller 60 to include a function that acquires data that is used for a parity calculation from another FMPK 50, and to acquire information showing the configuration of the RAID group from the system controller 20.

### REFERENCE SIGNS LIST

20: system controller, 30: storage system, 50: FMPK, 60: FM controller.

1. A storage system, comprising:
a plurality of nonvolatile memory devices that each include a storage area that is allocated to a RAID group; and
a storage controller that is a controller configured to perform input and output of data to and from the plurality of nonvolatile memory devices,
wherein each nonvolatile memory device is provided with a plurality of nonvolatile memory chips, and a nonvolatile memory controller that is a controller coupled to the nonvolatile memory chips and configured to perform input and output of data to and from the plurality of nonvolatile memory chips,
wherein the nonvolatile memory controller is configured to:
identify a failure occurrence area that is a storage area in which a failure has occurred in the plurality of nonvolatile memory chips;
exclude the failure occurrence area from a storage area that is allocated to the RAID group; and
transmit failure occurrence information that is information relating to a failure that has occurred in the nonvolatile memory device to the storage controller, and
wherein the storage controller is configured to:
receive the failure occurrence information; and
when the failure occurrence information is received, reconstruct data that had been stored in a storage area including at least the failure occurrence area of the nonvolatile memory device.

2. A storage system according to claim 1,
wherein the nonvolatile memory controller is configured to include failure occurrence area information that shows a logical area of the RAID group that corresponds to the failure occurrence area in the failure occurrence information, and transmit the failure occurrence information.

3. A storage system according to claim 2,
wherein the storage controller is configured to reconstruct data that had been stored in a logical area that is shown by the failure occurrence area information, in the nonvolatile memory device that includes the failure occurrence area.

4. A storage system according to claim 1,
wherein the storage controller is configured to reconstruct all data of the RAID group that had been stored in the nonvolatile memory device that transmits the failure occurrence information in a different nonvolatile memory device.

5. A storage system according to claim 2,
wherein the nonvolatile memory controller is configured to detect a failure occurrence area of the nonvolatile memory chip in the nonvolatile memory device at fixed intervals.

6. A storage system according to claim 2,
wherein the nonvolatile memory controller is configured to detect a failure occurrence area in the nonvolatile memory device by taking as a unit at least one kind among kinds including a group of nonvolatile memory chips that are coupled to a same bus, a nonvolatile memory chip, a die that is arranged in a nonvolatile memory chip, and a block in a nonvolatile memory chip.

7. A storage system according to claim 2,
wherein the storage controller is configured to determine whether to reconstruct all data that had been stored in the nonvolatile memory device that includes the failure occurrence area in a different nonvolatile memory device, or to reconstruct data that had been stored in a logical area that is shown by the failure occurrence area information in the nonvolatile memory device that includes the failure occurrence area, and reconstruct data based on a determined result.

8. A storage system according to claim 1,
wherein the storage controller is configured to determine whether to reconstruct data without replacing the nonvolatile memory device or to replace the nonvolatile memory device, and in a case where the storage controller determines to reconstruct data without replacing the nonvolatile memory device, the storage controller is configured to reconstruct the data, and in a case where the storage controller determines to replace the nonvolatile memory device, the storage controller is configured to reconstruct data after replacing the nonvolatile memory device.

9. A storage system according to claim 1,
wherein the storage controller is configured to send a query to check failure occurrence information to the nonvolatile memory controller, and
wherein the nonvolatile memory controller is configured to, when the query to check failure occurrence information is received, transmit the failure occurrence information to the storage controller if an occurrence of a failure in the nonvolatile memory device is detected.

10. A storage system according to claim 2,
wherein the nonvolatile memory controller is configured to:
store a correspondence between logical areas and physical areas of the RAID group; and
transmit logical area information showing a logical area that corresponds to the failure occurrence area as the failure occurrence area information.

11. A storage system according to claim 10,
wherein a storage device of the nonvolatile memory device is configured to store physical/logical conversion information with which, based on the physical area, it is possible to search for a logical area of the RAID group that corresponds to the physical area, and
wherein the nonvolatile memory controller is configured to identify the logical area information based on the physical/logical conversion information.

12. A storage system according to claim 2,
wherein the nonvolatile memory controller is configured to:
control so as to store data of a chunk that is a group of a predetermined plurality of logical area units of the RAID group in a physical area of a nonvolatile memory chip of a bus group that is coupled to a same bus; and
identify a logical area of a chunk for which data is stored in the failure occurrence area, and transmit logical area information showing the logical area of the chunk as the failure occurrence area information.

13. A storage control method for a storage system that comprises a plurality of nonvolatile memory devices that each include a plurality of nonvolatile memory chips, and a storage controller configured to perform input and output of data to and from a RAID group comprised by storage areas of a plurality of the nonvolatile memory devices,
wherein the nonvolatile memory device:
identifies a failure occurrence area that is a storage area in which a failure has occurred in the plurality of nonvolatile memory chips of the nonvolatile memory device;
excludes the failure occurrence area from a storage area that is allocated to the RAID group; and
transmits failure occurrence information that is information relating to a failure that has occurred in the nonvolatile memory device to the storage controller, and
wherein the storage controller, when the failure occurrence information is received, reconstructs data that had been stored in a storage area including at least the failure occurrence area of the nonvolatile memory device.

14. A storage control method according to claim 13,
wherein the nonvolatile memory controller includes failure occurrence area information that shows a logical area of the RAID group that corresponds to the failure occurrence area in the failure occurrence information, and transmits the failure occurrence information.

15. A storage control method according to claim 13,
wherein the storage controller reconstructs all data of the RAID group that had been stored in the nonvolatile memory device that transmits the failure occurrence information in the nonvolatile memory device.
